(19) United States
(12) Patent Application Publication
(10) Pub. No.: US 2023/0111037 A1
(43) Pub. Date: Apr. 13, 2023

(54) LIGHT CONVERTING DEVICE AND FILM CARTRIGE USED IN THE SAME

(71) Applicant: SHERPA SPACE INC., Daejeon (KR)

(72) Inventors: Wonjoon CHOI, Suwon (KR); Jonghwan KIM, Daejeon (KR); Sageun KANG, Sejong (KR); Choa Mun YUN, Daejeon (KR)

(21) Appl. No.: 17/512,024

(22) Filed: Oct. 27, 2021

(30) Foreign Application Priority Data
Oct. 12, 2021 (KR) 10-2021-034897

(51) Int. Cl. F21S 4/28; F21V 19/00; F21K 9/64

(52) U.S. Cl. CPC F21S 4/28; F21K 9/64; F21V 19/0035; F21Y 2115/10

(57) ABSTRACT

A lighting device is provided. The lighting device includes a body on which a substrate on which a plurality of light sources are disposed, is mounted on a front surface of the body and configured to extend in a length direction, a film cartridge including a film divided into a plurality of radiation areas having different light conversion characteristics, and a pair of roll bars configured to wind both ends of the film, a driving unit coupled to one side surface of the body and configured to apply driving force to one end of each of the roll bars to change the radiation areas of the film, and a side cover coupled to a remaining side surface of the body to support a remaining end of each of the roll bars.

### CROSS-REFERENCE TO RELATED APPLICATION

This application claims priority from Korean Patent Application No. 10-2021-0034897, filed on Oct. 12, 2021 in the Korean Intellectual Property Office, the disclosure of which is incorporated herein by reference in its entirety.

### BACKGROUND

### Technical Field

Apparatuses and methods consistent with exemplary embodiments relate to a lighting device and a film cartridge used in the same, and more particularly, to a lighting device which includes a body provided with a substrate, having a plurality of light sources disposed thereon, mounted on the front surface of the body and configured to extend in the length direction, a film cartridge including a film divided into a plurality of radiation areas having different light conversion characteristics, and a pair of roll bars configured to wind both ends of the film thereon, a driving unit combined with one side surface of the body and configured to apply driving force to one end of each of the roll bars to change radiation areas of the film, and a side cover combined with the other side surface of the body and configured to support the other end of each of the roll bars, and a film cartridge used in the lighting device.

### Description of the Related Art

In general, technology which uses artificial light for various plant cultivation is currently being widely researched and is being applied as a technology for plant factories.

Further, the agricultural field is at a turning point with the advent of LEDs, and while conventional lighting devices emit light in a wide wavelength band to match human vision, LEDs may adjust the wavelength ratio and intensity of emitted light, and may thus provide the wavelength and amount of light necessary for photosynthesis and easily implement illumination for plant cultivation.

An artificial lighting device using the LEDs may reduce or eliminate the usage of chemical fertilizers, may radiate light effectively to control plant growth, may implement low pesticide cultivation through application of LED technology for pest control, may reduce energy consumption by 80% or more compared to conventional incandescent lamps, and may produce crops for a year regardless of climate change because the LEDs are eco-friendly products without using mercury or heavy metals.

The intensity of light is closely related to the degree of photosynthesis and affects plant growth and the form of plants, and among infrared light, visible light and ultraviolet light, visible light has the greatest influence on growth of crops.

That is, it is known that certain bands of light wavelengths affect plant cultivation.

Conventionally, technologies which use light sources configured to intensively radiate light of a specific wavelength band that promotes photosynthesis, such as light emitting diode (LED) light sources, without lighting devices that irradiate light of all wavelength bands, such as incandescent and fluorescent lamps, fluorescent lamps has been proposed in plant cultivation.

Conventional lighting devices using the LED light sources are disclosed in Korean Patent Registration No. 10-0902071 entitled “Plant forcing culture method and device using LED lamps”, Korean Patent Unexamined Publication No. 10-2004-0010426 entitled “Factory and apparatus for culturing dye plants using LED light source”, Korean Patent Registration No. 10-0879711 entitled “Illumination device for cultivating plants with LEDs” and Korean Patent Unexamined Publication No. 10-2009-0124155 entitled “Light equipment for growing plants and intelligent photonic environment control system using LEDs”.

However, the most conventional lighting devices for cultivating plants using LEDs as light sources mix blue light and red light at a fixed ratio and repeat turning on and off with a pulse period capable of maximizing a photosynthetic rate, and it is difficult to adjust the wavelength band of the light sources in various ways, such as promoting photosynthesis according to a growth stage of a plant species such as seedling culture, differentiation, fruit setting, fruitification, or promoting morphogenesis or flower bud differentiation.

### Bibliography

PROJECT SERIAL NO.: 1545024479
PROJECT No.:421008-04
RELEVANT MINISTRY: Korea Ministry of Agriculture, Food and Rural Affairs, Korea Ministry of Science and ICT, and Korea Rural Development Administration
RESEARCH AND MANAGEMENT ORGANIZATION: Korea Institute of Planning and Evaluation for Technology in Food, Agriculture and Forestry, Korea Smart Farm R&D Foundation
RESEARCH PROJECT NAME: Smart Farm Ministries-collaborative Package Innovative Technology Development Project
RESEARCH SUBJECT NAME: Development of High Temperature and High Humidity-Type Smart Greenhouse Package Model for Export
CONTRIBUTION RATE: 100%
PROJECT EXECUTION ORGANIZATION: Sherpa Space Inc.
RESEARCH PERIOD: 2021. 4. 7 ~ 2024. 12. 31

### SUMMARY

Aspects of one or more exemplary embodiments provide a film cartridge including a film divided into a plurality of radiation areas having different light conversion characteristics, a pair of roll bars configured to wind both ends of the film thereon, and first support brackets combined with both ends of the roll bars to maintain a regular distance between the roll bars, so as to be easily replaced.

Aspects of one or more exemplary embodiments also provide a film cartridge including a film divided into a plurality of radiation areas having different wavelength change characteristics or a film divided into a plurality of radiation areas having different scattering degree characteristics so as to control growth of plants in more detail.

Aspects of one or more exemplary embodiments also provide a lighting device in which a unit configured to connect two or more film modules is provided such that a single motor may be used to transmit driving force thereof to each film module so as to cover a wider radiation area.

According to an aspect of an exemplary embodiment, there is provided a lighting device including a body on which a substrate on which a plurality of light sources are disposed, are mounted on a front surface of the body and configured to extend in a length direction, a film cartridge including a film divided into a plurality of radiation areas having different light conversion characteristics, and a pair of roll bars configured to wind both ends of the film, a driving unit coupled to one side surface of the body and configured to apply driving force to one end of each of the roll bars to change the radiation areas of the film, and a side cover coupled to a remaining side surface of the body to support a remaining end of each of the roll bars.

The film cartridge may further include first support brackets configured such that each of the first support brackets is coupled to one end of each of the roll bars to maintain a constant distance between the roll bars.

Each of the first support brackets may include a plate-type member, and two embedding holes disposed at both ends of the plate-type member to receive one end of each of the roll bars, and a bolt hole configured to fix the film cartridge to the side cover or the driving unit may be formed at a designated position of the plate-type member.

The film cartridge may include two film modules, each film module including the film, the pair of roll bars and the first support bracket, the two film modules may be connected and supported by a second support bracket, and the second support bracket may be combined with a remaining end of each of the roll bars of each of film module, and is configured such that the corresponding first support bracket is not coupled.

Hinge holes may be formed at parts of both ends of the body, and the lighting device may further include a lighting cover combined with the hinge holes formed at the ends of the body so as to be opened and closed.

The driving unit may include a driving motor configured to have a sun gear combined therewith, and a gear arrangement bracket provided with mounted thereon a swing gear interlocked with the sun gear, and a first planet gear and a second planet gear configured such that each of the first planet gear and the second planet gear is separably combined with one end of a corresponding one of the roll bars, and the swing gear may be moved along a hemispherical orbital hole formed in the gear arrangement bracket depending on a direction of rotation of the sun gear, and may be interlocked with the first planet gear or the second planet gear.

A driving shaft may be mounted at a center of each of the first planet gear and the second planet gear, and a slit groove may be formed at one end of the driving shaft so that one end of a corresponding one of the roll bars is inserted into the slit groove.

According to an aspect of another exemplary embodiment, there is provided a film cartridge detachably mounted in the lighting device, the film cartridge including a film divided into a plurality of radiation areas having different light conversion characteristics, a pair of roll bars configured to wind both ends of the film thereon, and first support brackets configured such that each of the first support brackets is combined with one end of each of the roll bars to maintain a constant distance between the roll bars.

Each of the first support brackets may include a plate-type member, and two embedding holes disposed at both ends of the plate-type member to receive one end of each of the roll bars, and a bolt hole configured to fix the film cartridge to the side cover or the driving unit of the lighting device may be formed at a designated position of the plate-type member.

The film cartridge may include two film modules, each film module including the film, the pair of roll bars and the first support bracket, the two film modules may be connected and supported by a second support bracket, and the second support bracket may be combined with a remaining end of each of the roll bars of each of the two film modules, configured such that the corresponding first support bracket is not coupled.

A flat-type proj ection may be formed at one end of each of the roll bars to be inserted into a slit groove formed at one end of a corresponding one of driving shafts mounted on a first planet gear and second planet gear of the driving unit of the lighting device.

The film may be divided into a plurality of radiation areas having different wavelength change characteristics.

The film may be divided into a plurality of radiation areas having different scattering degree characteristics.

### BRIEF DESCRIPTION OF THE DRAWINGS

The above and other aspects and features will be more clearly understood from the following description of the exemplary embodiments with reference to the accompanying drawings, in which:

FIG. 1 is a perspective view illustrating a lighting device according to an exemplary embodiment;

FIG. 2 is a perspective view illustrating an inside of the lighting device according to an exemplary embodiment;

FIG. 3 is a perspective view illustrating a configuration of a body and a film cartridge according to an exemplary embodiment;

FIG. 4 is an exploded perspective view illustrating a configuration of the lighting device according to an exemplary embodiment;

FIG. 5 is a view illustrating unfolded state of a film according to an exemplary embodiment;

FIG. 6 is an enlarged exploded perspective illustrating one end of the lighting device according to an exemplary embodiment;

FIG. 7 is an enlarged perspective view illustrating one end of the lighting device according to an exemplary embodiment;

FIG. 8 is an enlarged exploded perspective view illustrating a portion of a driving unit of the lighting device according to an exemplary embodiment;

FIG. 9 is an enlarged perspective view illustrating the portion of the driving unit of the lighting device according to an exemplary embodiment;

FIGS. 10A and 10B are views illustrating an operating principle of a driving unit according to one embodiment;

FIG. 11 is a view illustrating an operating principle of a driving unit according to another embodiment;

FIGS. 12 and 13 are cross-sectional and perspective views illustrating a power interlocking unit of the driving unit according to another exemplary embodiment;

FIGS. 14 and 15 are conceptual views illustrating operating principles of driving units according to other exemplary embodiments; and

FIG. 16 is a perspective view illustrating a lighting system provided by combining a plurality of lighting devices according to one or more exemplary embodiments into a module.

### DETAILED DESCRIPTION

Hereinafter reference will be made in detail to the preferred embodiments, examples of which are illustrated in the accompanying drawings. In the following description with reference to the drawings, elements having substantially the same functions are denoted by the same reference numerals even though they are depicted in different drawings, and a detailed description thereof will be omitted when it may make the subject matter of the present invention rather unclear.

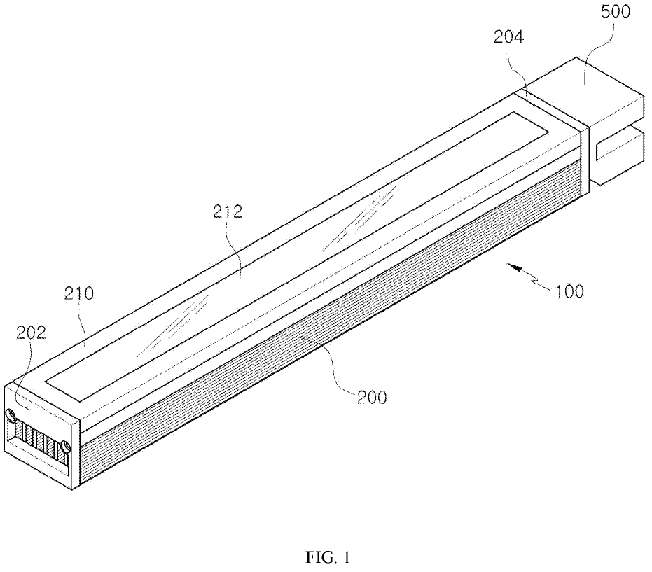

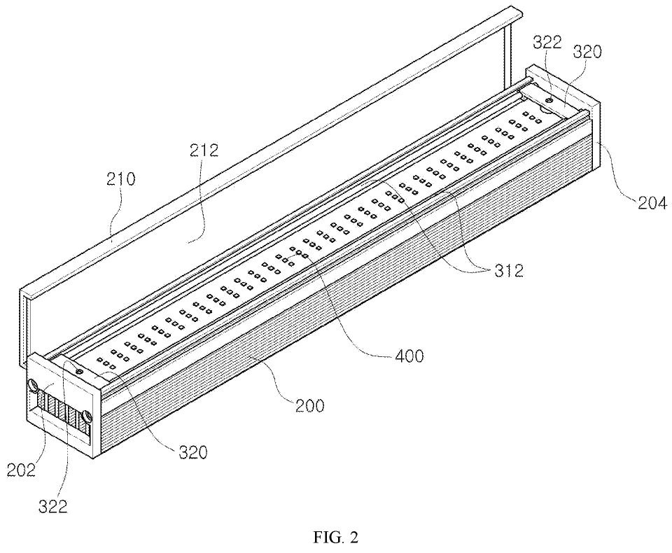

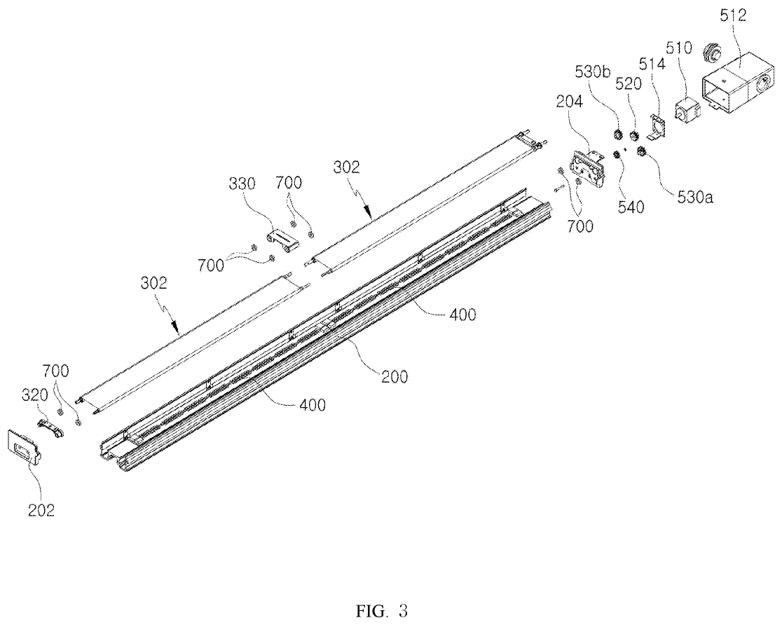

FIG. 1 is a perspective view illustrating a lighting device according to an exemplary embodiment, FIG. 2 is a perspective view illustrating an inside of the lighting device according to an exemplary embodiment, and FIG. 3 is a perspective view illustrating a configuration of a body and a film cartridge according to an exemplary embodiment.

As shown in FIGS. 1 to 3, a lighting device 100 includes a body 200, a film cartridge 300 having a long rod shape and mounted in the body 200, and a lighting cover 210 rotated to easily replace the film cartridge 300. The lighting cover 210 is combined with hinge holes formed at parts of both ends of the body 200 so as to be opened and closed, and a light-transmitting window 212 formed of a transparent or semi-transparent material to transmit light emitted from light sources provided therein to the outside is provided at a part or the entirety of the lighting cover 210.

Further, radiation fins 230 may be formed integrally with the outer surface of the body 200 to radiate heat generated by a plurality of light sources in the body 200 to the outside. The radiation fins 230 may help extend the life of the film cartridge 300 by preventing a film 310 from being deformed by heat applied to the film 310 to some extent.

Further, the film cartridge 300 is configured to be easily separated from the body 200 by opening the lighting cover 210.

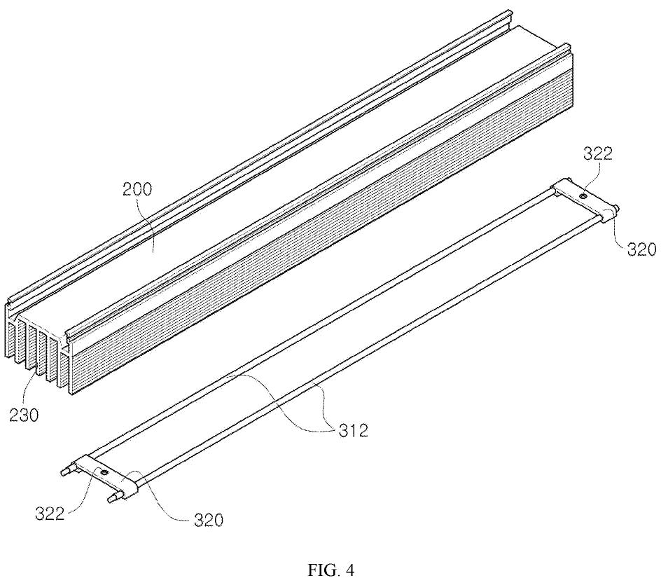

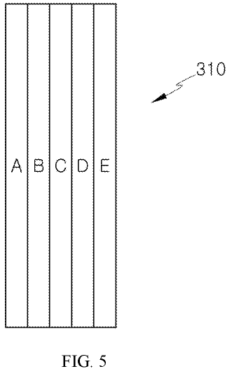

FIG. 4 is an exploded perspective view illustrating a configuration of the lighting device according to an exemplary embodiment, and FIG. 5 is a view illustrating the unfolded state of the film according to an exemplary embodiment.

As shown in FIGS. 4 and 5, the lighting device 100 includes the film cartridge 300 including the film 310 having a front surface mounted on a substrate 400 on which a plurality of light sources, such as LEDs, configured to emit light necessary to cultivate plants and divided into a plurality of radiation areas having different light conversion characteristics in the body 200 extending in the length direction, and a pair of roll bars 312 configured to wind both ends of the film 310 thereon.

In the film 310 wound around the film cartridge 300, the surface of the film 310 in contact with light emitted by the light sources may be selected by a driving unit 500 coupled to one side surface of the body 200 to provide driving force to one end of each of the roll bars 312 to change the radiation areas of the film 310.

In addition, the roll bars 312 are supported by a side cover 202 configured to support the other end of each of the roll bars 312 opposite the end of each of the roll bars 312 contacting the driving unit 500, and the side cover 202 is combined the other side surface of the body 200 opposite the side surface of the body 200 with which the driving unit 500 is combined.

The film cartridge 300 further includes first support brackets 320, each of which is combined with one end of each of the roll bars 312 to maintain a constant distance between the roll bars 312.

As shown in FIG. 4, the film cartridge 300 may include two film modules 302, each of which includes the film 310, a pair of roll bars 312, and the first support bracket 320.,The two film modules 302 are connected and supported by a second support bracket 330, and the second support bracket 330 may be combined with the other end of each of the roll bars 312 of each of the two film modules 302 with which the corresponding first support bracket 302 is not combined.

When the film cartridge 300 is formed by connecting the two film modules 302 so that light emitted from a plurality of the light sources installed on the substrate 400 can be transmitted by the film cartridge 300, a lighting device may be economically manufactured with only one driving unit 500, as compared to connection of two lighting devices in series.

FIG. 5 illustrates the unfolded state of the film 310 wound on the roll bars 312, and the film 310 is divided into a plurality of radiation areas having different light conversion characteristics.

For example, the film 310 may use at least one of quantum dots, inorganic fluorescent substances and perovskites having different wavelengths in each of the divided radiation areas A-E, or may use scattering substances having different scattering degrees in each of the divided radiation areas A-E. That is, the film 310 may be divided into a plurality of radiation areas having different wavelength conversion characteristics, or may be divided into a plurality of radiation areas having different scattering degree characteristics.

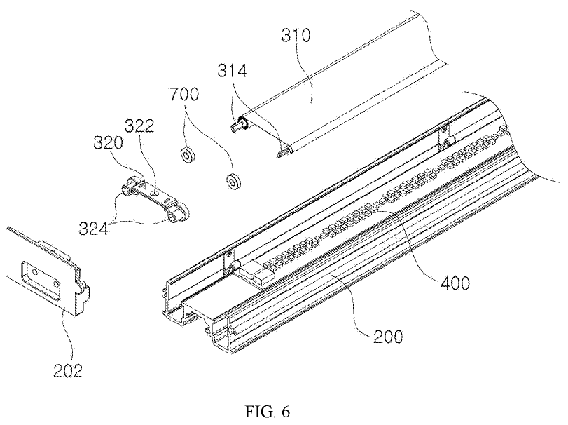

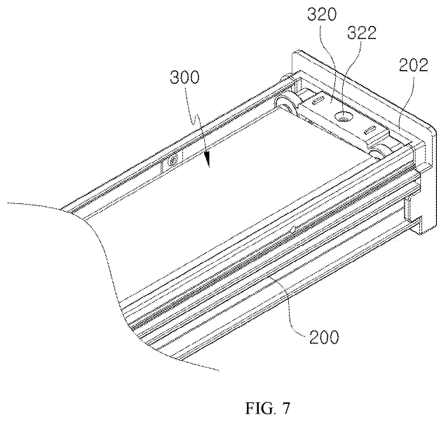

FIG. 6 is an enlarged exploded perspective illustrating one end of the lighting device according to an exemplary embodiment, and FIG. 7 is an enlarged perspective view illustrating one end of the lighting device according to an exemplary embodiment.

As shown in FIGS. 6 and 7, the first support bracket 320 includes a plate-type member and two embedding holes 324 disposed at both ends of the plate-type member to receive one end of each of the roll bars 312, and a bolt hole 322 configured to fix the film cartridge 300 to the side cover 202 or the driving unit 500 is formed at a designated position of the plate-type member.

A shaft ring 700 into which one end of each of the roll bars 312 is inserted to more smoothly rotate the corresponding roll bar 312 may be inserted into each of the embedding holes 324, and flat-type grooves corresponding to flat-type proj ections 314 formed by processing ends of the roll bars 312 may be formed in the inner circumferential surfaces of each of the shaft rings 700 so that the flat-type proj ections 314 are inserted into the shaft rings 700.

Further, the bolt hole 322 configured to be fixedly coupled to a screw hole formed in the side cover 202 or a gear arrangement bracket of the driving unit 500 by inserting a bolt into the bolt hole 322 and the screw ole may be formed in the first support bracket 320. However, as a method for coupling the film cartridge 300 to the side cover 202 or the driving unit 500, the bolt coupling is just one example, and, other coupling methods such as protrusion and groove coupling, or any combination of two or more coupling methods may be used without being limited thereto.

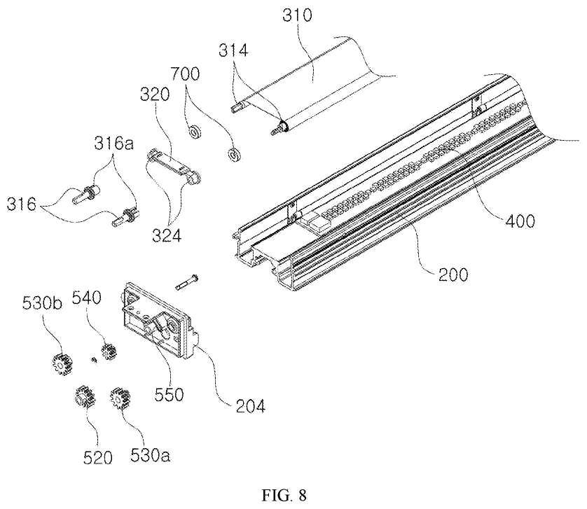

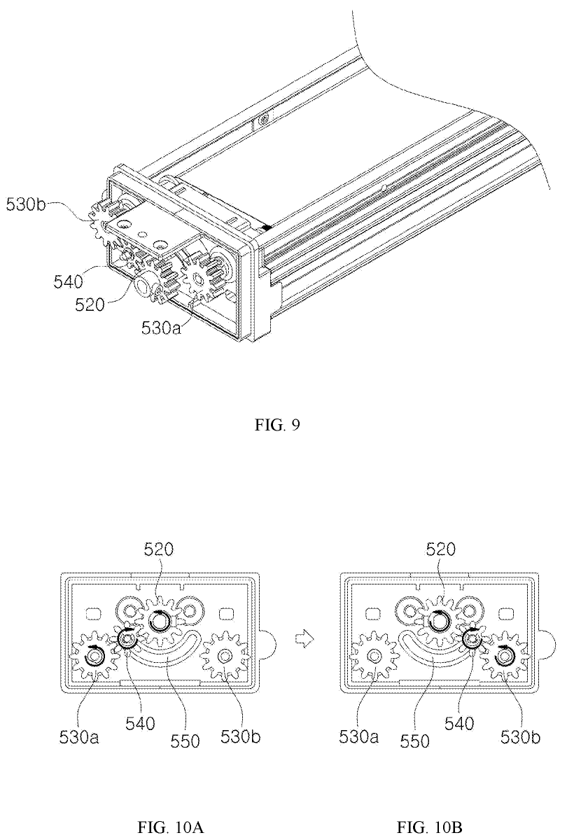

FIG. 8 is an enlarged exploded perspective view illustrating a portion of the driving unit of the lighting device according to an exemplary embodiment, and FIG. 9 is an enlarged perspective view illustrating the portion of the driving unit of the lighting device according to an exemplary embodiment.

As shown in FIGS. 4, 8 and 9, the driving unit 500 includes a driving motor 510 configured to have a sun gear 520 combined therewith, and the gear arrangement bracket provided with a swing gear 540 interlocked with the sun gear 520, and a first planet gear 539a and a second planet gear 530b, each of which is separably combined with one end of a corresponding one of the roll bars 312, and the swing gear 540 is moved along a hemispherical orbital hole 550 formed in the gear arrangement bracket depending on the direction of rotation of the sun gear 520, and is interlocked with the first planet gear 530a or the second planet gear 530b.

A driving shaft 316 is mounted at a center of each of the first planet gear 530a and the second planet gear 530b, and a slit groove 316a is formed at one end of the driving shaft 316 so that one end of a corresponding one of the roll bars 312 is inserted into the slit groove 316a.

The flat-type projection 314 is formed at one end of each of the roll bars 312 so as to be inserted into and engaged with the slit groove 316a formed in the driving shaft 315 of the first planet gear 530a or the second planet gear 530b.

However, the slit groove 316a of the driving shaft 316 is not limited thereto, and may be formed in a slit type having one of various polygonal shapes such as a triangle, a rectangle, a star, etc.

Further, the shaft ring 700 serving as a bearing so that one end of each of the roll bars 312 is inserted thereinto to more smoothly rotate the roll bar 312 may be inserted into each of the embedding holes 324 of the first support bracket 320, and a flat-type groove corresponding to the flat-type projection 314 may be formed in the inner circumferential surface of each of the shaft rings 700 so that one end of a corresponding one of the driving shafts 316 formed to have a shape corresponding to the flat-type projection 314 may be inserted into the shaft ring 700.

In addition, the driving motor 510 is combined with a coupling piece 514 and is stably fixed in the state in which the driving motor 510 is provided in a motor case 512.

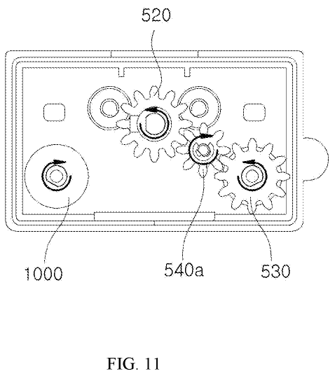

FIGS. 10A and 10B are views illustrating the operating principle of a driving unit according to one embodiment.

As shown in FIGS. 10A and 10B, when a sun gear 520 is rotated in the counterclockwise direction, a swing gear 540 engaged between the sun gear 520 and a first spur gear 530a is rotated in the clockwise direction and is moved rightwards along an orbital hole 550. The moved swing gear 540 is engaged between the sun gear 520 and a second spur gear 530b and rotates the first spur gear 530b in the counterclockwise direction. On the other hand, in order to rotate the first spur gear 530a in the clockwise direction, the swing gear 540 is moved leftwards along the orbital hole 550 so as to be engaged with the first spur gear 530a by rotating the sun gear 520 in the clockwise direction.

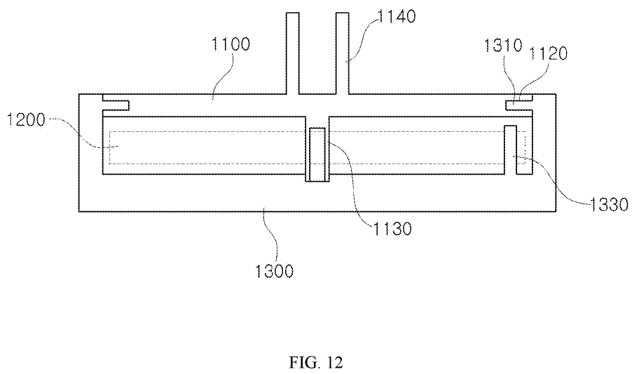

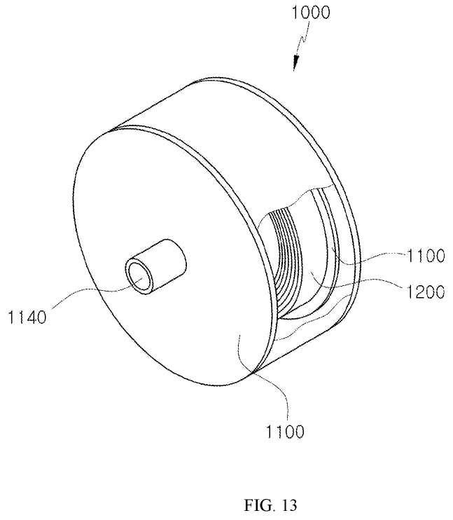

FIG. 11 is a view illustrating the operating principle of a driving unit according to another embodiment, and FIGS. 12 and 13 are cross-sectional and perspective views illustrating a power interlocking unit of the driving unit according to another embodiment.

As shown in FIGS. 11 to 13, the driving unit includes a power interlocking unit 1000 configured to apply rotating force in the clockwise direction to a roll bar 312 making a pair with another roll bar 312 combined with the spur gear 530, when the rotating force of a driving gear 520 is transmitted to a pinion gear 540a to rotate a spur gear 530 in the counterclockwise direction.

Although FIG. 11 illustrates an example in which the rotating force of the driving gear 520 is transmitted to the spur gear 530 through the pinion gear 540a, the rotating force of the driving gear 520 may be transmitted directly to the spur gear 530 without the pinion gear 540a. Further, the rotating force of the driving gear 520 may be transmitted to the spur gear 530 by a power transmission unit configured to connect the driving gear 520 and the spur gear 530. Here, the power transmission unit means a conveyer belt, a chain sprocket or a part configured to perform a similar function thereto.

The power interlocking unit 1000 is operated in a similar manner as a reel cable-type elastic tape measure which may be automatically wound using elastic restoring force generated when the tape measure is stretched.

The power interlocking unit 1000 includes a spiral spring 1200, a rotor 1100 in which a shaft mount part 1140 is formed at the upper end of the shaft mounting part 1140 and any one of the driving shafts 316 is inserted into the shaft mount part 1140, and an insertion shaft 1130 inserted into the center of the spiral spring 1200, and a stator 130 provided with an inner space configured to receive the spiral spring 1200 and a spring fixing protrusion 1330 formed in one side of the inner space and configured to fix one end of the spiral spring 1200. Further, a guide groove 1120 and a guide protrusion 1310 may be formed in the outer circumferential surface of the rotor 1100 and on the inner circumferential surface of the upper end of the stator 1300 to prevent the rotor 1100 from being released from the stator 1300 and to guide smooth rotation of the rotor 1100.

The stator 1300 is fixedly coupled to a portion inside the motor case 512.

When the film 310 is wound by rotating the roll bar 312 combined with the spur gear 530, restoring force is stored in the spiral spring 1200, and when the film wound on the roll bar 312 combined with the spur gear 530 is unwound, proper tensile force is applied to the film 310 by stored restoring force without any separate external power, and thus, the film 310 may be wound and unwound without sagging.

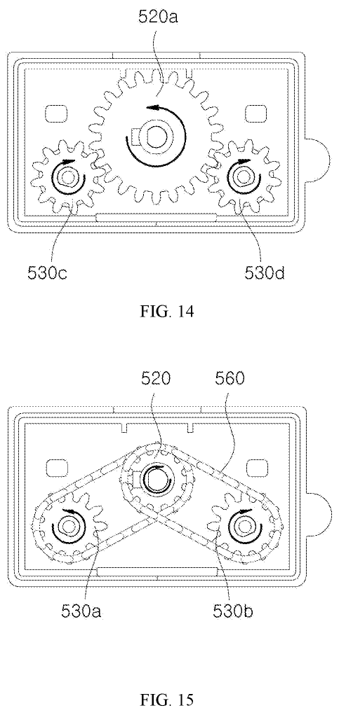

FIG. 14 is a conceptual view illustrating the operating principle of a driving unit according to another embodiment.

Referring to FIG. 14, a driving gear 520a is directly connected to two spur gears 530c and 530d. Therefore, when the driving gear 520a is rotated in the counterclockwise direction, the roll bars 312 combined with the spur gears 530c and 530d are rotated in the clockwise direction and, when the driving gear 520a is rotated in the clockwise direction, the roll bars 312 combined with the spur gears 530c and 530d are rotated in the counterclockwise direction

FIG. 15 is a conceptual view illustrating the operating principle of a driving unit according to another embodiment.

Referring to FIG. 15, a driving gear 520 is connected to two spur gears 530a and 530b by power transmission units 560. As described above, the power transmission unit 560 means a conveyer belt, a chain sprocket or a part configured to perform a similar function thereto.

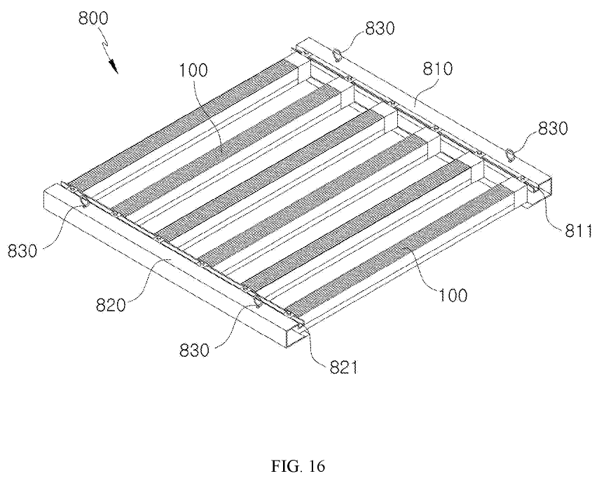

FIG. 16 is a perspective view illustrating a module-type lighting system provided by combining a plurality of lighting devices according to an exemplary embodiment on one frame.

As shown in FIG. 16, a module-type lighting system 800 is provided by mounting a plurality of lighting devices 100 according to any one of the exemplary embodiments shown in FIGS. 1 to 15 on a first coupling frame 810 and a second coupling frame 820.

Referring to FIG. 16, a bracket mounted on the first coupling frame 810 or the second coupling frame 820 may be further provided at each of both ends of the lighting devices 100. After the respective brackets are combined with sliding grooves 811 and 821 formed in the first coupling frame 810 and the second coupling frame 820 and are moved to proper positions, the brackets are fixed to the first coupling frame 810 and the second coupling frame 820 by inserting bolts into bolt fixing holes formed in the brackets.

A plurality of hook-type or groove-type hangers 830 configured to hang the module-type lighting system 800 from the ceiling may be provided at the upper ends of the first coupling frame 810 and the second coupling frame 820. The module-type lighting system 800 may be suspended from the ceiling of a greenhouse or cultivation equipment by connecting a wire to the hangers 830.

As is apparent from the above description, one or more exemplary embodiments provide a lighting device including a film cartridge including a film divided into a plurality of radiation areas having different light conversion characteristics, a pair of roll bars configured to wind both ends of the film thereon, first support brackets combined with both ends of the roll bars to maintain a regular distance between the roll bars, thereby enabling the film cartridge to be easily replaced.

Further, the film cartridge includes a film divided into a plurality of radiation areas having different wavelength change characteristics or a film divided into a plurality of radiation areas having different scattering degree characteristics, thereby being capable of controlling growth of plants in more detail.

In addition, a unit configured to connect two or more film modules may be provided such that a single motor may be used to transmit driving force thereof to the respective film modules so as to cover a wider radiation area.

While exemplary embodiments have been described with reference to the accompanying drawings, it is to be understood by those skilled in the art that various modifications in form and details may be made therein without departing from the sprit and scope as defined by the appended claims. Therefore, the description of the exemplary embodiments should be construed in a descriptive sense and not to limit the scope of the claims, and many alternatives, modifications, and variations will be apparent to those skilled in the art.

1. A lighting device comprising:
a body on which a substrate on which a plurality of light sources are disposed, are mounted on a front surface and configured to extend in a length direction;
a film cartridge comprising a film divided into a plurality of radiation areas having different light conversion characteristics and a pair of roll bars configured to wind both ends of the film;
a driving unit coupled to one side surface of the body, disposed at one end of the body in the length direction, and configured to apply driving force to one end of each of the roll bars to change the radiation areas of the film; and
a side cover coupled to an opposing side surface of the body, disposed at an opposing end of the body in the length direction, to support a remaining end of each of the roll bars,
wherein:
hinge holes are formed at parts of both ends of the body; and
the lighting device further comprises a lighting cover combined with the hinge holes formed at the ends of the body so as to be opened and closed.

2. The lighting device according to claim 1, wherein the film cartridge further comprises first support brackets configured such that each of the first support brackets is coupled to one end of each of the roll bars to maintain a constant distance between the roll bars.

3. The lighting device according to claim 2, wherein each of the first support brackets comprises a plate-type member and two embedding holes disposed at both ends of the plate-type member to receive one end of each of the roll bars,
wherein a bolt hole configured to fix the film cartridge to the side cover or the driving unit is formed at a designated position of the plate-type member.

4. The lighting device according to claim 2, wherein the film cartridge comprises two film modules, each film module comprising the film, the pair of roll bars and the first support bracket;
wherein the two film modules are connected and supported by a second support bracket, and the second support bracket is combined with a remaining end of each of the roll bars of each film module, and is configured such that the corresponding first support bracket is not coupled.

5. (canceled)

6. The lighting device according to claim 1, wherein the driving unit comprises:
a driving motor configured to have a sun gear combined therewith; and
a gear arrangement bracket provided with mounted thereon a swing gear interlocked with the sun gear, and a first planet gear and a second planet gear configured such that each of the first planet gear and the second planet gear is separably combined with one end of a corresponding one of the roll bars,
wherein the swing gear is moved along a hemispherical orbital hole formed in the gear arrangement bracket depending on a direction of rotation of the sun gear, and is interlocked with the first planet gear or the second planet gear.

7. The lighting device according to claim 6, wherein:
a driving shaft is mounted at a center of each of the first planet gear and the second planet gear; and
a slit groove is formed at one end of the driving shaft so that one end of a corresponding one of the roll bars is inserted into the slit groove.

8. A film cartridge for lighting devices detachably mounted in the lighting device according to claim 1, the film cartridge comprising:
a film divided into a plurality of radiation areas having different light conversion characteristics;
a pair of roll bars configured to wind both ends of the film thereon; and
first support brackets configured such that each of the first support brackets is combined with one end of each of the roll bars to maintain a constant distance between the roll bars.

9. The film cartridge for lighting devices according to claim 8, wherein each of the first support brackets comprises a plate-type member and two embedding holes disposed at both ends of the plate-type member to receive one end of each of the roll bars,
wherein a bolt hole configured to fix the film cartridge to the side cover or the driving unit of the lighting device is formed at a designated position of the plate-type member.

10. The film cartridge for lighting devices according to claim 8, wherein the film cartridge comprises two film modules, each film module comprising the film the pair of roll bars and the first support bracket;
wherein the two film modules are connected and supported by a second support bracket, and the second support bracket is combined with a remaining end of each of the roll bars of each of the two film modules configured such that the corresponding first support bracket is not coupled.

11. The film cartridge for lighting devices according to claim 8, wherein:
a flat-type projection is formed at one end of each of the roll bars so as to be inserted into a slit groove formed at one end of a corresponding one of driving shafts mounted on a first planet gear and second planet gear of the driving unit of the lighting device.

12. The film cartridge for lighting devices according to claim 8, wherein the film is divided into a plurality of radiation areas having different wavelength change characteristics.

13. The film cartridge for lighting devices according to claim 8, wherein the film is divided into a plurality of radiation areas having different scattering degree characteristics.
